(19) United States
(12) Patent Application Publication
(10) Pub. No.: US 2004/0142824 A1
(43) Pub. Date: Jul. 22, 2004

(54) Method for the manufacture of a high temperature superconducting layer

(76) Inventors: Kai Numssen, Munich (DE); Helmut Kinder, Freising (DE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/684,811

(22) Filed: Oct. 14, 2003

(30) Foreign Application Priority Data
Oct. 21, 2002 (DE) 10248962.9-33

(51) Int. Cl. B05D 5/12

(52) U.S. Cl. 505/470; 427/58

(57) ABSTRACT

The present invention relates to a method for the manufacture of a high temperature-superconducting layer on a substrate (1a, 1b) comprising the steps of depositing an RBa₂Cu₃O₇-layer (2) with a low growth rate, wherein R represents yttrium, an element of the group of rare-earth elements (atomic number 57 to 71) or mixtures of two or more of these elements, and the deposition of an XBa₂Cu₃O₇-layer (3) onto the RBa₂Cu₃O₇-layer (2) with high growth rate, wherein X represents yttrium, an element of the group of rare-earth elements (atomic number 57-71) or mixtures of two or more of these elements. Preferably, the low growth rate is <1 nm/s and the high growth rate is >1 nm/s, preferably >2 nm/s and the RBa₂Cu₃O₇-layer (2) is preferably deposited onto an at least biaxially textured substrate (1a) or a substrate with an at least biaxially textured buffer layer (1b).

### 1. TECHNICAL FIELD

The present invention relates to a method for the manufacture of a superconductor.

### 2. THE PRIOR ART

Thin films of high temperature superconductors (HTS) are used for applications in power technology. The disappearance of the electric resistance below the transition temperature T_{c} allows an increase of the efficiency of various devices for storing, transforming or the transport of electric energy.

In an ideal situation the HTS-thin layer is deposited on a thin metal tape of a great length (HTS tape conductor). Such an HTS tape conductor can replace copper conductors in established applications which are loaded with high currents. These high currents lead to heavy ohmic losses in the copper. Using superconductors these losses can be avoided.

In addition, applications can be improved wherein already nowadays the copper is replaced by conventional superconductors. The HTS allow a substantially higher operating temperature and resists higher magnetic fields. The resulting reduction of the efforts for cooling increases the efficiency. Furthermore, there are applications wherein the substrate should not be electrically conductive. In these cases other substrates such as ceramics can be used instead of the metal tape.

For technical applications the ability of the superconductor to carry current is of particular interest. This is measured by the critical current density j_{c}, defined as the current per cross-section of a conductor which creates an electric field of 1 μV/cm in the superconductor. The critical current density j_{c} is commonly indicated at a temperature of 77.4 K (boiling temperature of liquid nitrogen).

The typically used superconducting material is nowadays YBa₂Cu₃O₇ (YBCO) having a transition temperature shortly above 92 K and critical current densities of several MA/cm². Alternatively, also homologous RBa₂Cu₃O₇-Compounds are used. In the following R represents yttrium, an element of the group of rare-earth elements (atomic number 57-71) or mixtures of two or more of these elements. Exceptions in the series of rare-earth elements are the elements Cer (Ce) and praseodym (Pr). Since Ce is typically tetravalent in components, there are no Ce-components homologous to YBCO. PrBa₂Cu₃O₇ exists, however, it is only superconducting, if extremely pure Pr-materials and if particular manufacturing conditions are used. As explained in the publication of Z. Zou et al. in Phys. Rev. Lett. 80, page 1074-1077 (1998) a superconduction was even in this case only observed in parts of the sample. In most cases already minor impurities make PrBa₂Cu₃O₇ semiconducting and not superconducting.

Among the RBa₂Cu₃O₇ components which are superconductant only components which are present as a single crystalline ordered layer (epitaxial layer) show a high capability to carry current. For manufacturing highly-ordered epitaxial layers either a textured substrate is needed (single crystal or metal foil having a texture by rolling) or a textured buffer layer on non-textured substrates (for example ceramics, foils of stainless steel).

For the manufacture of such RBa₂Cu₃O₇-thin layers there are several established methods which are for example discussed in the publication of H. Kinder et al. Physica C 282-287, page 107 (1997) and the publication of J. Geerk et al. in IEEE Trans. On Appl. Supercond. 11 No. 1, page 3856-3858 (2001) and in the DE 39 14 476, wherein it can be distinguished between in situ and ex situ deposition methods:

In situ methods relate predominantly to methods of physical deposition or so-called chemical vapor deposition (CVD) wherein the components of a superconductor are deposited in vacuum under suitable conditions onto a heated substrate. When the components reach the substrate they directly react and form the desired crystal lattice structure, wherein the crystalline orientation of the substrate is taken over (epitaxy). For the formation of coatings of the best quality having a high capability to carry current (>1 MA/cm²) with a growth is performed at comparatively low rates of less than 1 nm/s. If the deposition rate is increased to several nm/s, the critical current density of the film is reduced, in particular on the non-perfect substrates such as metal tapes or polycrystalline ceramic substrates with artificially oriented buffer layers. These leads to comparatively long deposition times.

In the ex situ methods an amorphous precursor is at first deposited by means of chemical, physical or mechanical deposition methods. This precursor comprises all essential metallic components of the superconductor. However, it does not have a crystalline order and is therefore not a superconductor. The transformation occurs typically by the application of temperatures beyond 600° C. in a suitable gas mixture which supports the phase transformation and which adjusts the necessary oxygen content. Crystallization starts in an ideal situation close to the boundary to the crystalline substrate. Under suitable process conditions the crystallization front can run with a comparatively high velocity >1 nm/s through the precursor material to the surface, until it is used up. However, in case of a high transition velocity also here substantial decreases of the critical capability to carry current is observed. Also in this case the process parameters such as the temperature and the oxygen pressure are selected such that the transition velocity is slow enough to allow a growth of high quality layers with a high current density. Thus, also in this case considerable time is necessary for the overall manufacture of the layer.

In order to overcome these difficulties and for the manufacture of high quality RBa₂Cu₃O₇-layers, multilayer systems were already described in the literature which help to improve the growth of the HTS—functional layer. For example in the U.S. Pat. No. 5,712,227 it is described how the quality of a BiSrCaCuO-layer can be improved on a MgO-substrate without a well-adapted lattice structure using an intermediate layer of YBCO.

In the case of a further problematic substrate material α-Al₂O₃ (sapphire) which causes problems concerning the diffusion of aluminum into the superconductor, an La₂₋ₓSrₓCuO₄-intermediate layer was suggested in the U.S. Pat. No. 5,162,294 for improving the HTS-layer. On dielectric substrates also thin superconducting buffer layers were described, in particular from RBa₂Cu₃O₇, which helped to improve the growth of a subsequent further XBa₂Cu₃O₇-layer (wherein R and X are rare-earth elements or Y or mixtures of two of two or more of these elements), cf. the disclosure of the WO 00/16412 and the JP 01063212.

However, in both cases a low deposition rate (0.0667 nm/s) is preferably used for the two-layer structure or a method having inherently a low deposition rate (sputtering, molecular beam epitaxy (MBE)). The improvement of the HTS-quality is therefore mainly based on an improvement of the chemical compatibility of the HTS-layer and the substrate. In particular, the deposition of the intermediate layer is in all cases performed with similar growth rates as the actual functional layer. This leads also here to correspondingly long manufacturing times.

Also for the growth of single crystals from the melt RBa₂Cu₃O₇-seed layers on a dielectric substrate were already described, cf. the U.S. Pat. No. 5,869,431. The growth of single crystals, however, occurs in contrast to the deposition of a layer close to thermodynamic equilibrium. The growth of the RBa₂Cu₃O₇-layer is selected such that its melting temperature is above of the XBa₂Cu₃O₇-crystal so that the seed layer is maintained during dipping into the melt and the seed layer can serve as a starting point for crystallization.

As explained, all of the above described methods require a considerable amount of time. The coating of long metal substrates, however, can only be economically performed using a high volume growth rate. The present invention is therefore based on the problem to provide a method allowing a fast growth of an HTS-conductor without simultaneously reducing the quality of the layer and its current density.

### 3. SUMMARY OF THE INVENTION

The present invention relates to a method for the manufacture of a high temperature superconductor on a substrate with the steps of depositing an RBa₂Cu₃O₇-layer onto the substrate with a low growth rate, wherein R represents yttrium, an element of the group of rare-earth elements (atomic number 57-71) or mixtures of two or more of these elements, and the deposition of an XBa₂Cu₃O₇-layer on the RBa₂Cu₃O₇-layer with a high growth rate, wherein X represents yttrium, an element of the group of rare-earth elements (atomic number 57-71) or mixtures of two or more of these elements.

The invention is based on the recognition that even high quality crystal growth can occur very rapidly, if the substrate onto which subsequent layers are deposited has a very similar chemistry and crystallography to the deposited film. In an ideal case it is the same material; such a case is called homoepitaxy; heteroepitaxy, on the contrary, is a case wherein the chemistry and the crystallography of the substrate and the deposited material are different. The difference in the chemical potentials and the surface energies (surface tension) determine the growth mode and may cause island growth or layer growth. The more similar the chemical potentials and the surface energies, the easier and faster will the atoms at the growth boundary adhere to the already existing crystalline surface.

If excessive growth rates are used in case of heteroepitaxy, there is no sufficient time for the deposited atoms at the substrate boundary for an ordered arrangement. Defects of the structure of the crystal are created, which will not heal even under further growth in thickness and which will impair the overall quality of the layer. According to the invention, these defects are avoided by depositing at first an RBa₂Cu₃O₇-layer with a low growth rate which serves preferably as a kind of seed layer for the subsequent XBa₂Cu₃O₇-layer which is deposited with a high growth rate and which presents the actual functional layer of the high temperature superconductor.

The low growth rate is preferably <1 nm/s and the high growth rate is preferably >1 nm/s, preferably >2 nm/s. The RBa₂Cu₃O₇-layer, therefore, grows sufficiently slow for an ordered deposition. Due to the chemical similarity to the first RBa₂Cu₃O₇-seed layer, which is arranged below, the subsequent XBa₂Cu₃O₇-layer can be deposited with a higher growth rate to increase the overall productivity in the manufacture of the HTS-layer.

The RBa₂Cu₃O₇-layer has preferably a maximum thickness of 500 nm, particularly preferably 100 nm and is preferably at least 5 nm thick. The XBa₂Cu₃O₇-layer has preferably a thickness of >1 μm.

Preferably, the RBa₂Cu₃O₇-layer is deposited onto an at least biaxially textured substrate or a substrate having an at least biaxially textured buffer layer. This induces the required crystallographic order in the RBa₂Cu₃O₇-layer.

According to a further embodiment, the XBa₂Cu₃O₇-layer is deposited as a precursor layer comprising the metal components of the high temperature superconducting layer. This precursor layer is preferably transformed by a temperature treatment into a superconducting XBa₂Cu₃O₇-layer in a further method step with a high transformation rate. Also in this alternative embodiment the RBa₂Cu₃O₇-layer of the invention, which is at first deposited with a low growth rate, assures that the subsequent fast transformation of the precursor layer arranged on the RBa₂Cu₃O₇-layer leads to an XBa₂Cu₃O₇-layer of sufficient quality, which allows to obtain very high critical current densities. The transformation rate is preferably >2 nm/s. It is particularly preferred, if R is a rare-earth element having a great ion radius (La, Pr, Nd, Sm, Eu, Gd) or compounds which comprise these elements to at least 50% in mixtures with other rare earth elements, since layers from these materials have the tendency of a good growth on top of substrate defects and can compensate such defects.

### 4. SHORT DESCRIPTION OF THE DRAWINGS

In the following presently preferred embodiments of the invention are described in detail making reference to the following figures, which show:

FIG. 1: Schematic representation of the sequence of layers of an HTS-layer system, produced with a first embodiment of the method according to the invention; and

FIG. 2: Schematic representation of the layer sequence of a HTS-layer system produced with a second embodiment of the method according to the invention.

### 5. DETAILED DESCRIPTION OF THE INVENTION

The growth of single crystalline layers from a solid phase (precursor) or directly from the gas phase occurs far from thermodynamical equilibrium. The higher the growth velocity the greater the distance from equilibrium. The difficulties related to this non-equilibrium state for the fast manufacture of ordered HTS layers for high current densities are overcome with the embodiments of the method according to the invention, as described in the following.

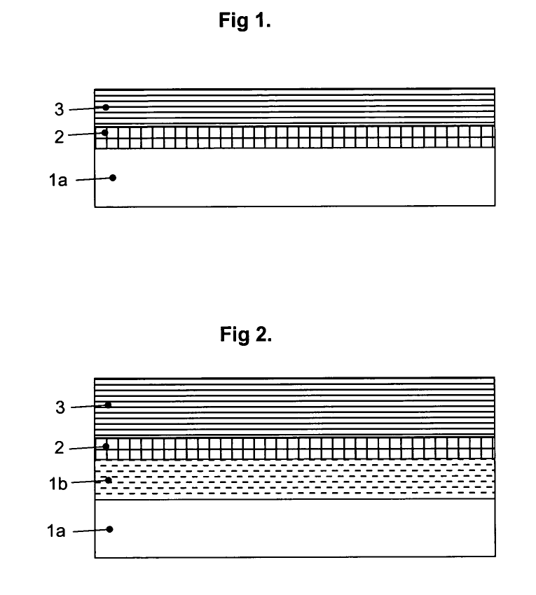

The growth of HTS-layers with a high rate and high critical current densities is achieved in a first preferred embodiment of the invention, which leads to the layer system of FIG. 1, by depositing at first a 5-500 nm thin RBa₂Cu₃O₇-layer onto a substrate 1a having at least on its surface biaxially textured regions, for example a dielectric single crystal or a textured metal tape, with a low growth rate <1 nm/s using a conventional technique, for example sputtering, PLD, CVD, vacuum deposition etc.

In a second method step, an up to several micrometer thick XBa₂Cu₃O₇-functional layer 3 is deposited with a high rate deposition method or a fast crystallization onto the seed layer 2. Due to the similarity of the materials of the seed layer 2 and the functional layer 3, the growth is almost homoepitaxial, i.e. the formation of defects close to the surface is suppressed and the quality of the layer improved so that high critical current densities >1 MA/cm² can be achieved. It is to be noted that the layer thicknesses in FIG. 1 (and FIG. 2) are only schematic and not to scale.

According to a modification of the first embodiment leading to the layer system of FIG. 2, an RBa₂Cu₃O₇-seed layer 2 is deposited onto a substrate 1a with at least one biaxially textured buffer layer (1b) using the mentioned standard deposition methods, wherein the RBa₂Cu₃O₇-seed layer 2 is also biaxially textured and wherein a low deposition rate of <1 nm/s is used. This seed layer is followed by the XBa₂Cu₃O₇-functional layer 3, which is deposited with a high growth rate >2 nm/s.

Due to the substantially higher deposition rate for the XBa₂Cu₃O₇-functional layer 3 with respect to the prior art, there are substantial advantages in productivity in the manufacture of HTS-layers.

### EXAMPLES

1. A 5-200 nm thick RBa₂Cu₃O₇-seed layer 2 is manufactured with a low growth rate <1 nm/s using a standard deposition method on a dielectric single crystal 1a, for example MgO, Al₂O₃, YSZ (yttrium stabilized zirconium oxide) or on a biaxially textured metal substrate, such as silver, a silver alloy, nickel, a nickel alloy or a composite material comprising these materials. Using a fast deposition method with a high rate >2 nm/s, an up to several micrometer thick superconducting XBa₂Cu₃O₇-layer 3 is deposited onto this layer.

2. A 5-200 thick RBa₂Cu₃O₇-layer 2 is produced with a low growth rate <1 nm/s using a standard deposition method on a substrate 1a having a biaxially textured buffer layer lb. The superconducting XBa₂Cu₃O₇-layer 3, which is up to several micrometers thick, is deposited onto this layer using a fast deposition method with a high rate >2 nm/s.

3. A 5-200 nm thick RBa₂Cu₃O₇-layer 2 is produced with a low growth rate <1 nm/s using a standard deposition method on a dielectric single crystal 1a, for example MgO, Al₂O₃, YSZ (yttrium stabilized zirconium oxide) or on a biaxially textured metal substrate, such as silver, a silver alloy, nickel, a nickel alloy or a composite material from these materials. Using a fast deposition, a precursor layer, which is up to several micrometers thick, is deposited onto this layer by chemical or mechanical methods, wherein the precursor layer comprises the metal components (cations) of the desired superconducting functional layer. This precursor layer is transformed by a temperature treatment with a high transformation rate, preferably >2 nm/s into a superconducting XBa₂Cu₃O₇-layer 3.

4. A 5-200 nm thick RBa₂Cu₃O₇-layer 2 is produced with a low growth rate <1 nm/s using a standard deposition method on a substrate 1a with biaxial textured buffer layer 1b. A precursor layer being up to several micrometers thick is deposited onto this layer by means of a fast deposition method or by chemical or mechanical methods, wherein the precursor layer comprises the metal components (cations) of the desired superconducting functional layer. The precursor layer is transformed by temperature treatment with a high transformation rate, preferably >2 nm/s into a superconducting XBa₂Cu₃O₇-layer 3.

5. A 5-200 nm thick semiconducting PrBa₂Cu₃O₇-layer 2 is produced with a low growth rate <1 nm/s using a standard deposition method on a textured substrate 1a or a substrate having a biaxially textured buffer layer 1b. Using a fast deposition method with a high rate >2 nm/s an XBa₂Cu₃O₇-layer 3, which is up to several micrometers thick, is deposited onto this layer.

1. Method for the manufacture of a high temperature superconducting layer on a substrate (1a, 1b) comprising the following steps:
a. deposition of an RBa₂Cu₃O₇-layer (2) onto the substrate (1a, 1b) with a low growth rate, wherein R represents yttrium, an element of the group of rare-earth elements (atomic number 57-71) or mixtures of two or more of these elements;
b. deposition of an XBa₂Cu₃O₇-layer (3) onto the RBa₂Cu₃O₇-layer (2) with a high growth rate, wherein X represents yttrium, an element of the group of rare-earth elements (atomic number 57-71) or mixtures of two or more of these elements.

2. Method according to claim 1, wherein the low growth rate is <1 nm/s and wherein the high growth rate is >1 nm/s, preferably >2 nm/s.

3. Method according to claim 1 or 2, wherein the RBa₂Cu₃O₇-layer (2) comprises a thickness of <500 nm, preferably <100 nm.

4. Method according to one of the claims 1-3, wherein the RBa₂Cu₃O₇-layer (2) has a thickness of >5 nm.

5. Method according to one of the claims 1-4, wherein the XBa₂Cu₃O₇-layer (3) has a thickness of >1 μm.

6. Method according to one of the claims 1-5, wherein the RBa₂Cu₃O₇-layer (2) is deposited onto an at least biaxially textured substrate (1a) or a substrate with an at least biaxially textured buffer layer (1b).

7. Method according to one of the claims 1-6, wherein the XBa₂Cu₃O₇-layer (3) is deposited as a precursor layer, comprising the metal components of the high temperature superconducting layer.

8. Method according to claim 7, wherein the precursor layer is transformed in a further method step by a temperature treatment with a high transformation rate into a superconducting XBa₂Cu₃O₇-layer (3).

9. Method according to claim 8, wherein the transformation rate is >2 nm/s.

10. Method according to one of the claims 1-9, wherein R represents a rare-earth element with a great ion radius (La, Pr, Nd, Sm, Eu, Gd) or compounds comprising to at least 50% these elements in mixtures with other rare-earth elements

11. Layer system of a high temperature superconductor manufactured according to a method of any of the claims 1-10.
